(19) United States
(12) Patent Application Publication
(10) Pub. No.: US 2026/0008454 A1
(43) Pub. Date: Jan. 8, 2026

(54) DRIVING ASSISTANCE DEVICE, DRIVING ASSISTANCE METHOD, AND STORAGE MEDIUM

(71) Applicant: HONDA MOTOR CO., LTD., Tokyo (JP)

(72) Inventor: Fumiya Kobayashi, Tokyo (JP)

(21) Appl. No.: 19/232,907

(22) Filed: Jun. 10, 2025

(30) Foreign Application Priority Data
Jul. 4, 2024 (JP) 2024-108393

(51) Int. Cl. B60W 30/09; B60W 30/095; B60W 30/14; G06V 20/58

(52) U.S. Cl. CPC B60W 30/09; B60W 30/0956; B60W 30/146; G06V 20/58; B60W 2420/403; B60W 2420/408; B60W 2554/4042; B60W 2556/10

(57) ABSTRACT

A driving assistance device includes a storage medium storing computer-readable instructions, and a processor connected to the storage medium, the processor executing the computer-readable instructions to recognize another vehicle around a vehicle using at least one of a camera and a radar mounted on the vehicle, calculate a yaw rate of the other vehicle based on a speed vector of the other vehicle and estimate a predicted route of the other vehicle based on the yaw rate to calculate a time to collision until a point where the vehicle and the other vehicle collide with each other based on the estimated predicted route, and execute driving assistance for the vehicle in accordance with the calculated time to collision.

### CROSS-REFERENCE TO RELATED APPLICATION

Priority is claimed on Japanese Patent Application No. 2024-108393, filed Jul. 4, 2024, the content of which is incorporated herein by reference.

### BACKGROUND

### Field of the Invention

The present invention relates to a driving assistance device, a driving assistance method, and a storage medium.

### Description of Related Art

In recent years, efforts to provide access to sustainable transportation systems that take into consideration vulnerable traffic participants have been actively made. In order to achieve this, research and development that further improves traffic safety and convenience are brought into focus through research and development on preventive safety technology.

Incidentally, in preventive safety technology, when an obstacle is detected around a vehicle, driving assistance such as decelerating the vehicle is executed to avoid a collision with the obstacle, but on the other hand, it is an issue to appropriately curb excessive operation of driving assistance. For example, JP2018-101373A discloses technology for calculating a predicted route of a host vehicle on the basis of a yaw rate and determining a collision with an obstacle.

However, in the above-mentioned related art, the predicted route of the host vehicle is calculated on the basis of a yaw rate, predicted routes of other vehicles are calculated on the basis of a yaw rate with high accuracy, and the predicted routes are used to determine a collision with the host vehicle.

### SUMMARY

The present invention has been made in consideration of such circumstances, and an object thereof is to provide a driving assistance device, a driving assistance method, and a storage medium which are capable of calculating predicted routes of other vehicles with high accuracy on the basis of a yaw rate and using the predicted routes to determine a collision with a host vehicle. This will ultimately contribute to the development of a sustainable transportation system.

A driving assistance device, a driving assistance method, and a storage medium according to the present invention adopt the following configuration.
(1) A driving assistance device according to one aspect of the present invention includes a storage medium storing computer-readable instructions, and a processor connected to the storage medium, the processor executing the computer-readable instructions to recognize another vehicle around a vehicle using at least one of a camera and a radar mounted on the vehicle, calculate a yaw rate of the other vehicle based on a speed vector of the other vehicle and estimate a predicted route of the other vehicle based on the yaw rate to calculate a time to collision until a point where the vehicle and the other vehicle collide with each other based on the estimated predicted route, and execute driving assistance for the vehicle in accordance with the calculated time to collision.
(2) In the above aspect (1), the processor calculates the yaw rate of the other vehicle by taking a difference between the latest detection value of the speed vector of the other vehicle and the previous detection value.
(3) In the above aspect (1), the processor estimates the predicted route of the other vehicle based on an average value of the yaw rates calculated over a predetermined period of time in the past.
(4) In the above aspect (1), the processor estimates the predicted route of the other vehicle based on the latest value of the yaw rate.
(5) In the above aspect (1), the processor estimates the predicted route as a stationary circle defined by the yaw rate.
(6) In the above aspect (1), the processor specifies the point for each of the right and left ends of the vehicle and the other vehicle, and specifies, as a collision point, the point corresponding to the shortest time to collision among the times to collision to the respective points.
(7) In the above aspect (1), the processor decelerates the vehicle when the time to collision is equal to or less than a threshold value.
(8) In a driving assistance method according to another aspect of the present invention, a computer recognizes another vehicle around a vehicle using at least one of a camera and a radar mounted on the vehicle, calculates a yaw rate of the other vehicle based on a speed vector of the other vehicle and estimates a predicted route of the other vehicle based on the yaw rate to calculate a time to collision until a point where the vehicle and the other vehicle collide with each other based on the estimated predicted route, and executes driving assistance for the vehicle in accordance with the calculated time to collision.
(9) A computer-readable non-transitory storage medium according to another aspect of the present invention stores a program that causes a computer to recognize another vehicle around a vehicle using at least one of a camera and a radar mounted on the vehicle, calculate a yaw rate of the other vehicle based on a speed vector of the other vehicle and estimate a predicted route of the other vehicle based on the yaw rate to calculate a time to collision until a point where the vehicle and the other vehicle collide with each other based on the estimated predicted route, and execute driving assistance for the vehicle in accordance with the calculated time to collision.

According to (1) to (9), it is possible to provide a driving assistance device, a driving assistance method, and a storage medium which are capable of calculating predicted routes of other vehicles with high accuracy on the basis of a yaw rate and using the predicted routes to determine a collision with a host vehicle.

### BRIEF DESCRIPTION OF THE DRAWINGS

FIG. 1 is a diagram showing an example of the configuration of a driving assistance device mounted on a host vehicle.

FIG. 2 is a diagram showing an overview of driving assistance executed by a driving assistance unit.

FIG. 3 is a diagram showing an example of a scene in which a CMBS of a host vehicle is operated excessively.

FIG. 4 is a diagram showing a method of calculating a yaw rate by a calculation unit.

FIG. 5 is a diagram showing a method of extracting a turning center point candidate by the calculation unit.

FIG. 6 is a diagram showing a method of estimating a predicted route by the calculation unit.

FIG. 7 is another diagram showing a method of estimating a predicted route by the calculation unit.

FIG. 8 is a flowchart showing an example of a flow of processing executed by the driving assistance device.

### DESCRIPTION OF EMBODIMENTS

Hereinafter, embodiments of a driving assistance device, a driving assistance method, and a storage medium of the present invention will be described with reference to the drawings.

### [Configuration]

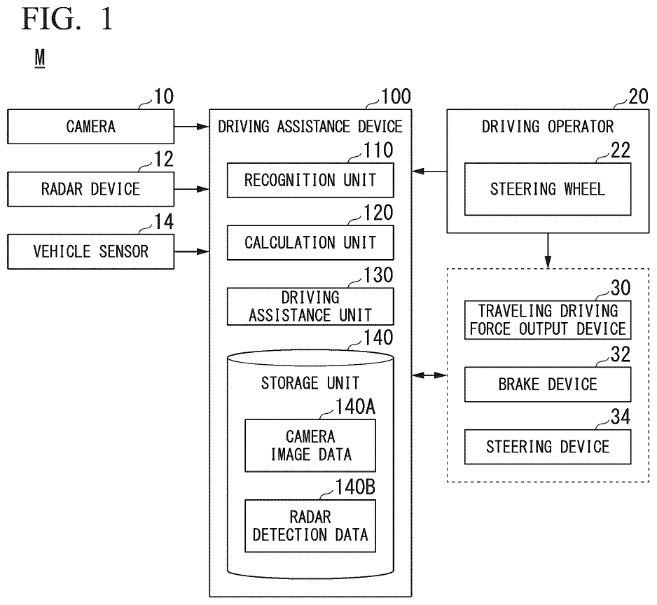

FIG. 1 is a diagram showing an example of the configuration of a driving assistance device 100 mounted on a host vehicle M. The host vehicle M includes, for example, a camera 10, a radar device 12, a vehicle sensor 14, a driving operator 20, a steering wheel 22, a traveling driving force output device 30, a brake device 32, a steering device 34, and the driving assistance device 100.

The camera 10 is a digital camera that uses a solid-state imaging element such as a charge coupled device (CCD) or a complementary metal oxide semiconductor (CMOS). The camera 10 is attached to any location of a vehicle (hereinafter, the host vehicle M) on which the driving assistance device 100 is mounted. When capturing an image of the front, the camera 10 is attached to an upper portion of a front windshield, a back face of an interior mirror, or the like. For example, the camera 10 periodically and repeatedly captures images of the surroundings of the host vehicle M. The camera 10 may be a stereo camera. The camera 10 transmits the captured images to the driving assistance device 100, and the driving assistance device 100 stores the received images in a storage unit 140 as camera image data 140A.

The radar device 12 emits radio waves such as millimeter waves around the host vehicle M and detects radio waves (reflected waves) reflected by an object to detect at least the position (distance and direction) of the object. The radar device 12 is attached to any location of the host vehicle M. The radar device 12 may detect the position and speed of the object using a frequency modulated continuous wave (FM-CW) method. The radar device 12 transmits a detection result to the driving assistance device 100, and the driving assistance device 100 stores the detection result in the storage unit 140 as radar detection data 140B.

The vehicle sensor 14 includes a vehicle speed sensor that detects the speed of the host vehicle M, an acceleration sensor that detects an acceleration, a yaw rate sensor that detects an angular velocity around a vertical axis, and a direction sensor that detects the direction of the host vehicle M.

The driving operator 20 includes, for example, an accelerator pedal, a brake pedal, a shift lever, and other operation devices, in addition to the steering wheel 22. The driving operator 20 is equipped with a sensor that detects the amount of operation or whether an operation has occurred, and the detection result is output to the driving assistance device 100 or to some or all of the traveling driving force output device 30, the brake device 32, and the steering device 34. The operator does not necessarily have to be annular, and may be in the form of an irregular steering wheel, a joystick, a button, or the like.

The traveling driving force output device 30 outputs a traveling driving force (torque) for causing the host vehicle M to travel to driving wheels. The traveling driving force output device 30 includes, for example, a combination of an internal combustion engine, an electric motor, and a transmission, and an electronic control unit (ECU) that controls them. The ECU controls the above-mentioned configuration in accordance with information input from the driving assistance device 100 or information input from the driving operator 20.

The brake device 32 includes, for example, a brake caliper, a cylinder that transmits hydraulic pressure to the brake caliper, an electric motor that generates hydraulic pressure in the cylinder, and a brake ECU. The brake ECU controls the electric motor in accordance with information input from the driving assistance device 100 or information input from the driving operator 20, so that a brake torque corresponding to a braking operation is output to each wheel. The brake device 32 may be provided with a backup mechanism that transmits hydraulic pressure generated by the operation of the brake pedal included in the driving operator 20 to the cylinder via a master cylinder. The brake device 32 is not limited to having the configuration described above, and may be an electronically controlled hydraulic brake device that controls an actuator in accordance with information input from the driving assistance device 100 and transmits hydraulic pressure from the master cylinder to the cylinder.

The steering device 34 includes, for example, a steering ECU and an electric motor. The electric motor changes the direction of steered wheels by applying a force to, for example, a rack and pinion mechanism. The steering ECU drives the electric motor to change the direction of the steered wheels in accordance with information input from the driving assistance device 100 or information input from the driving operator 20.

The driving assistance device 100 includes, for example, a recognition unit 110, a calculation unit 120, a driving assistance unit 130, and the storage unit 140. The recognition unit 110, the calculation unit 120, and the driving assistance unit 130 are implemented, for example, by causing a hardware processor such as a central processing unit (CPU) to execute a program (software). Some or all of these components may be implemented by hardware (including circuitry) such as a large scale integration (LSI), an application specific integrated circuit (ASIC), a field-programmable gate array (FPGA), a graphics processing unit (GPU), or a system on chip (SOC), or may be implemented by software and hardware in cooperation. Programs may be stored in advance in a storage device (a storage device including a non-transitory storage medium) such as a hard disk drive (HDD) or a flash memory, may be stored in a detachable storage medium (non-transitory storage medium) such as a DVD or CD-ROM, and may be installed by installing a storage medium in a drive device. The storage unit 140 is, for example, a HDD, a flash memory, a random access memory (RAM), or the like. The storage unit 140 stores, for example, the camera image data 140A and the radar detection data 140B.

The recognition unit 110 performs a sensor fusion process on detection results based on some or all of the camera image data 140A and the radar detection data 140B to recognize the position, type, speed, and the like of an object. For example, the recognition unit 110 performs image processing on the camera image data 140A to recognize pedestrians, other vehicles, road structures (road division lines, walls, and the like) that are captured in a camera image. The recognition unit 110 also recognizes pedestrians, other vehicles, road structures (walls and the like) around the host vehicle M on the basis of the radar detection data 140B.

When the recognition unit 110 recognizes another vehicle (more generally, an obstacle), the calculation unit 120 calculates a time to collision (TTC), which is a time until the host vehicle M collides with the object, on the basis of information (for example, a relative distance and a relative speed to the object) acquired from the recognition unit 110 and the vehicle sensor 14.

The driving assistance unit 130 performs driving assistance for the host vehicle M on the basis of a recognition result of the recognition unit 110. In this embodiment, “driving assistance” refers to a collision mitigation brake system (CMBS) that automatically activates the brake device 32 in order to avoid a collision of the host vehicle M with an obstacle around the host vehicle M or to reduce a collision speed. More specifically, when the calculation unit 120 calculates a TTC until the host vehicle M collides with an obstacle, the driving assistance unit 130 determines whether the calculated TTC is equal to or less than a threshold value. When the calculated TTC is equal to or less than the threshold value, the driving assistance unit 130 causes the host vehicle M to operate the CMBS.

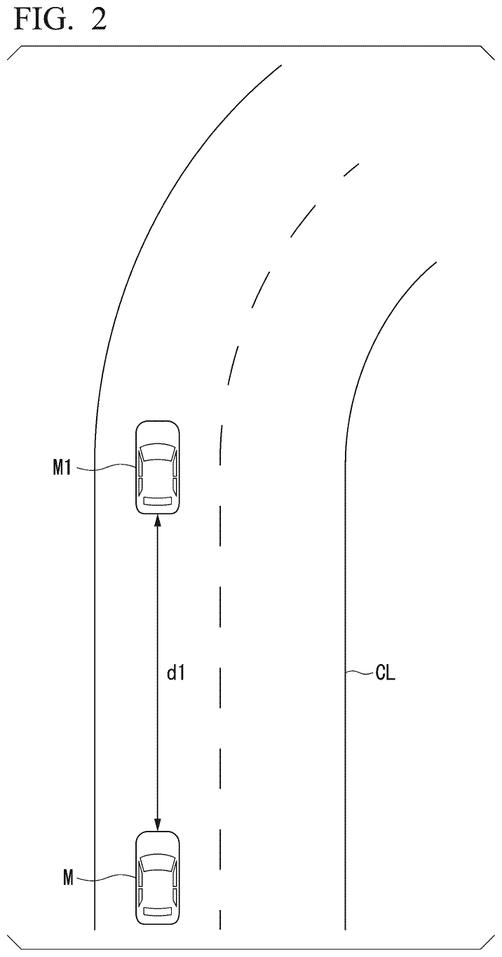

FIG. 2 is a diagram showing an overview of driving assistance executed by the driving assistance unit 130. In FIG. 2, symbol CL represents a road division line recognized on the basis of the camera image data 140A, and symbol M1 represents another vehicle. As shown in FIG. 2, the calculation unit 120 calculates, for example, TTC=d1/v on the basis of a distance d1 between the host vehicle M and another vehicle M1 and a relative speed v of the host vehicle M with respect to the other vehicle M1, and the driving assistance unit 130 causes the host vehicle M to operate the CMBS when the calculated TTC is equal to or less than the threshold value.

### [Suppression of Driving Assistance]

In this manner, when the TTC calculated by the calculation unit 120 is equal to or less than the threshold value, the driving assistance unit 130 causes the host vehicle M to operate the CMBS. However, for example, when the host vehicle M passes the other vehicle M1 at a roundabout or on a curved road, the TTC calculated on the basis of a speed vector of the other vehicle M1 becomes equal to or less than the threshold value, and the CMBS of the host vehicle M is excessively operated, even when the host vehicle M can travel without colliding with the other vehicle M1 due to the turning of the other vehicle M1.

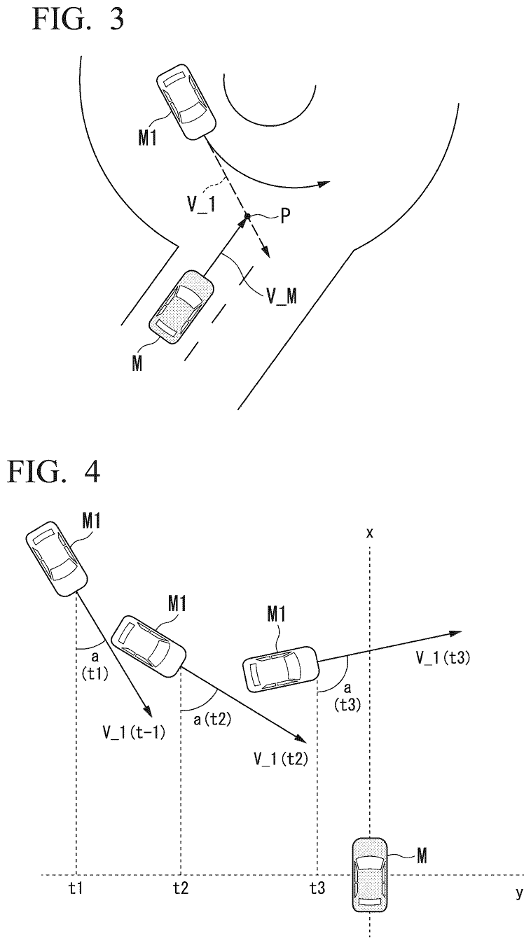

FIG. 3 is a diagram showing an example of a scene in which the CMBS of the host vehicle M is excessively operated. FIG. 3 shows, as an example, a scene in which the host vehicle M is about to enter a roundabout while the other vehicle M1 is turning left at the roundabout. Here, when the calculation unit 120 calculates a TTC on the basis of only a speed vector V_1 of the other vehicle M1 and a speed vector V_M of the host vehicle M, the driving assistance unit 130 predicts that the host vehicle M and the other vehicle M1 will collide at a point P and cause the host vehicle M to operate the CMBS. However, in reality, since the other vehicle M1 is turning, the host vehicle M and the other vehicle M1 will not collide at the point P, and as a result, the CMBS operated by the host vehicle M will be excessive.

In light of the above-described circumstances, the calculation unit 120 calculates the yaw rate of the other vehicle M1 on the basis of the detected speed of the other vehicle M1, estimates a predicted route of the other vehicle M1 on the basis of the yaw rate, and calculates a TTC until the host vehicle M collides with the other vehicle M1 on the basis of the estimated predicted route. Here, the speed of the other vehicle may be detected on the basis of time-series images of the other vehicle stored as the camera image data 140A, or may be detected on the basis of the radar detection data 140B.

FIG. 4 is a diagram showing a method of calculating a yaw rate by the calculation unit 120. FIG. 4 shows a coordinate system in which the center of gravity of the host vehicle M at a certain point in time is defined as the origin, the longitudinal direction of the host vehicle M is defined as an X axis, and the lateral direction thereof is defined as a Y axis. First, the calculation unit 120 detects a speed vector V_1(t)=(X_1(t), Y_1(t)) of the other vehicle M1 in a predetermined control cycle. More specifically, the calculation unit 120 detects a speed vector starting from the other vehicle M1 as a(t)=arctan(Y_1(t)/X_1(t)). In the case of FIG. 4, the calculation unit 120 detects, in a predetermined control cycle, a speed vector a(t1)=arctan(Y_1(t1)/X_1(t1)) of the other vehicle M1 at time t1, a speed vector a(t2)=arctan(Y_1(t2)/X_1(t2)) of the other vehicle M1 at time t2, a speed vector a(t3)=arctan(Y_1(t3)/X_1(t3)) of the other vehicle M1 at time t3, and the like.

When the calculation unit 120 detects the speed vector a(t) of the other vehicle M1, the yaw rate of the other vehicle M1 is calculated by taking a difference between the latest detection value of the speed vector of the other vehicle M1 and the previous detection value. More specifically, when a time width of the control cycle is represented as Δt, the calculation unit 120 calculates a yaw rate Yaw by Yaw(t)={a(t)−a(t−1)}/Δt(rad/s). When the yaw rate Yaw is calculated, the calculation unit 120 can derive a turning radius r=V_1/Yaw of the other vehicle M1 by a known method.

The calculation unit 120 may derive a turning radius r using the detection value of the latest yaw rate Yaw corresponding to the latest speed vector, or may derive the turning radius r of the other vehicle M1 on the basis of statistical values of a plurality of yaw rates calculated over the most recent specified period. For example, the calculation unit 120 may calculate average values V1_ave and Yaw_ave of the speed vector and yaw rate of the other vehicle M1 over the most recent predetermined period, and derive a turning radius R by r=V1_ave/Yaw_ave. By deriving the turning radius R using the average value of the yaw rate, a predicted route to be described below can be calculated with higher accuracy.

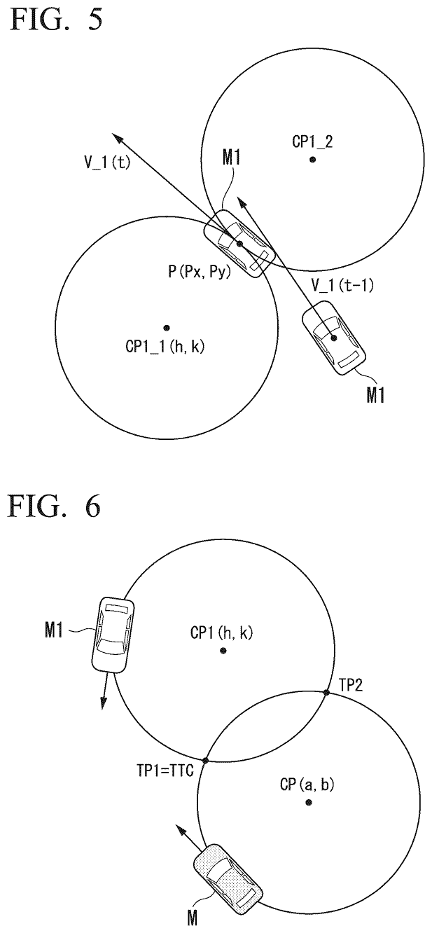

When the calculation unit 120 derives the turning radius r of the other vehicle M1, turning center point candidates of the other vehicle M1 are extracted using the derived turning radius r. FIG. 5 is a diagram showing a method of extracting turning center point candidates by the calculation unit 120. In FIG. 5, a point P(Px, Py) represents the current position of the other vehicle M1, and points CP1_1 and CP1_2 represent the extracted turning center point candidates of the other vehicle M1. When a gradient of the speed vector V_1(t) is m, the calculation unit 120 extracts turning center point candidates in accordance with the following Formula (1).

$$[ Math . 1 ]$$

$$h = P x ∓ \frac{m r}{\sqrt{( 1 + {m}^{⋀} 2 )}} \qquad ( 1 )$$

$$h = Py \pm \frac{r}{\sqrt{( 1 + {m}^{⋀} 2 )}}$$

When the calculation unit 120 extracts the turning center point candidates, a turning direction is predicted from the speed vector V_1(t), and a center point is determined. In the case of FIG. 5, for example, the calculation unit 120 predicts that the other vehicle M1 is turning counterclockwise on the basis of a transition from a speed vector V_1(t−1) at time t−1 to a speed vector V_1(t) at time t. In this case, the calculation unit 120 determines, as a turning center point, a point CP1_1 on the left side of the host vehicle M out of the turning center point candidates CP1_1 and CP1_2. Similarly, the calculation unit 120 acquires the yaw rate of the host vehicle M from the yaw rate sensor mounted on the host vehicle M, derives a turning radius, and determines the turning center point of the host vehicle M. In this manner, it is possible to calculate a predicted route of the host vehicle M with higher accuracy by using the latest detection value of the yaw rate sensor for the host vehicle M.

When the calculation unit 120 determines turning center points of the host vehicle M and the other vehicle M1, predicted routes of the host vehicle M and the other vehicle M1 are estimated on the basis of the determined turning center points. FIG. 6 is a diagram showing a method of estimating a predicted route by the calculation unit 120. In FIG. 6, CP1_1(h, k) represents the coordinates of the turning center point determined for the other vehicle M1, and CP1(a, b) represents the coordinates of the turning center point determined for the host vehicle M.

As an example, the calculation unit 120 estimates the predicted routes of the host vehicle M and the other vehicle M1 as stationary circles with the turning center points determined for the host vehicle M and the other vehicle M1 as a center and with the turning radius as a radius. When the calculation unit 120 estimates the predicted routes, the calculation unit 120 simulates the traveling of the host vehicle M and the other vehicle M1 on the stationary circle on the basis of the speeds of the host vehicle M and the other vehicle M1, and specifies an intersection point between the host vehicle M and the other vehicle M1 (a point corresponding to the shortest time to collision) as a collision point among intersection points of these predicted routes. In the case of FIG. 6, depending on the relative speeds of the host vehicle M and the other vehicle M1, an intersection point TP1 may be predicted as a collision point, an intersection point TP2 may be predicted as a collision point, or it may be predicted that the host vehicle M and the other vehicle M1 will not collide with each other.

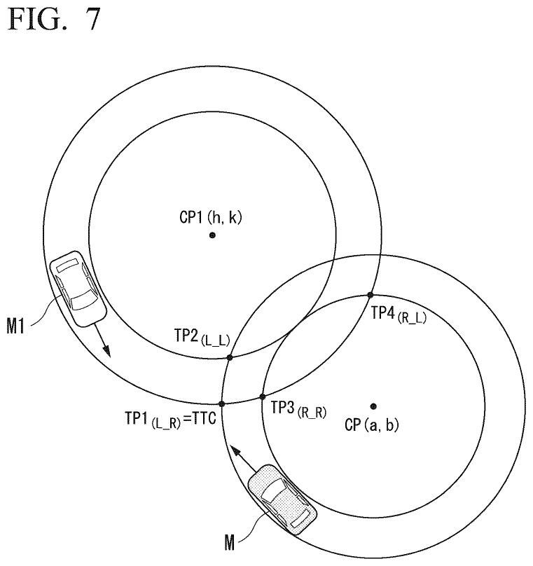

FIG. 7 is another diagram showing a method of estimating a predicted route by the calculation unit 120. The method of estimating a predicted route shown in FIG. 6 is a simplified simulation of traveling routes of the host vehicle M and the other vehicle M1 as trajectories having no width, but the traveling routes may be more accurately predicted as trajectories having a width in consideration of vehicle widths (right and left ends) of the host vehicle M and the other vehicle M1. As shown in FIG. 7, for example, the calculation unit 120 calculates a collision point TP1(L_R) where the left end of the host vehicle M is predicted to collide with the right end of the other vehicle M1, a collision point TP1(L_L) where the left end of the host vehicle M is predicted to collide with the left end of the other vehicle M1, a collision point TP1(R R) where the right end of the host vehicle M is predicted to collide with the right end of the other vehicle M1, and a collision point TP1(R_L) where the right end of the host vehicle M is predicted to collide with the left end of the other vehicle M1. The calculation unit 120 then simulates the traveling of the host vehicle M and the other vehicle M1 on a steady circle on the basis of the speeds of the host vehicle M and the other vehicle M1, and specifies, among these collision points, an intersection point between the host vehicle M and the other vehicle M1 (a point corresponding to the shortest time to collision) as a collision point. It is possible to further accurately calculate a TTC by performing a simulation that takes into account the vehicle widths of the host vehicle M and the other vehicle M1.

When the driving assistance unit 130 specifies a collision point, a time (TTC) until the host vehicle reaches the specified collision point is calculated. When the calculated TTC is equal to or less than a threshold value, the host vehicle M is caused to operate the CMBS. In this manner, when the host vehicle M or the other vehicle M1 is turning, a yaw rate is calculated on the basis of a speed vector of the turning vehicle, a predicted route is estimated on the basis of the calculated yaw rate, it is determined whether a collision with the other vehicle M1 has occurred, and a TTC is calculated. That is, this makes it possible to calculate a predicted route of the other vehicle with high accuracy on the basis of the yaw rate and use the predicted route to determine a collision with the host vehicle.

### [Flow of Control]

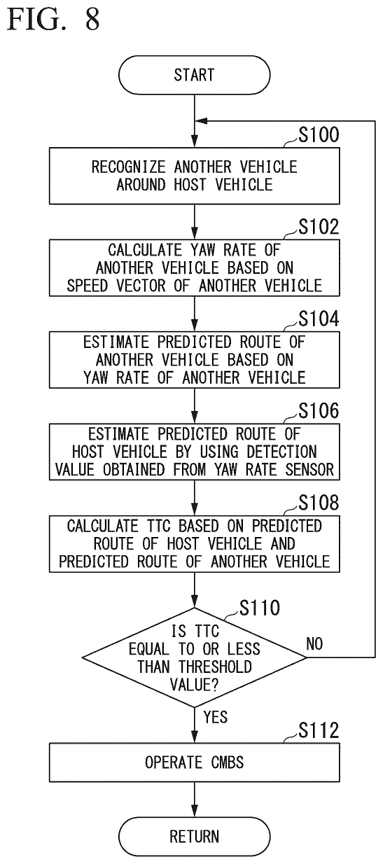

Next, a flow of processing executed by the driving assistance device 100 will be described with reference to FIG. 8. FIG. 8 is a flowchart showing an example of a flow of processing executed by the driving assistance device 100. The processing of the flowchart shown in FIG. 8 is repeatedly executed in a predetermined control cycle while the host vehicle M is traveling.

First, the recognition unit 110 recognizes another vehicle around the host vehicle M (step S100). Next, the calculation unit 120 calculates the yaw rate of the other vehicle on the basis of a speed vector of the recognized other vehicle (step S102). Next, the calculation unit 120 estimates a predicted route of the other vehicle on the basis of the calculated yaw rate of the other vehicle (step S104). Next, the calculation unit 120 estimates a predicted route of the host vehicle M by using a detection value obtained from the yaw rate sensor (step S106).

Next, the calculation unit 120 calculates a TTC on the basis of the predicted route of the host vehicle M and the predicted route of the other vehicle (step S108). Next, the driving assistance unit 130 determines whether the calculated TTC is equal to or less than a threshold value (step S110). When it is determined that the calculated TTC is not equal to or less than the threshold value, the driving assistance unit 130 causes the processing to return to step S100. On the other hand, when it is determined that the calculated TTC is equal to or less than the threshold value, the driving assistance unit 130 operates the CMBS (step S112). Thereby, the processing of this flowchart ends.

In the above-described flowchart of FIG. 8, the process of step S104 for estimating the predicted route of the other vehicle and the process of step S106 for estimating the predicted route of the host vehicle may be executed in the opposite order or simultaneously.

Furthermore, in the above-described embodiment, for example, in FIG. 3, a case where the host vehicle M enters a roundabout has been described, but the present invention is not limited to such a configuration and can be applied more generally to a scene where the other vehicle M1 is turning.

According to the present embodiment described above, it is possible to provide a driving assistance device, a driving assistance method, and a storage medium which are capable of calculating predicted routes of other vehicles with high accuracy on the basis of a yaw rate and using the predicted routes to determine a collision with a host vehicle. This can ultimately contribute to the development of a sustainable transportation system.

The above-described embodiment can be expressed as follows.

A driving assistance device including:
a storage medium storing computer-readable instructions; and
a processor connected to the storage medium, the processor executing the computer-readable instructions to
recognize another vehicle around a vehicle using at least one of a camera and a radar mounted on the vehicle,
calculate a yaw rate of the other vehicle based on a speed vector of the other vehicle and estimate a predicted route of the other vehicle based on the yaw rate to calculate a time to collision until a point where the vehicle and the other vehicle collide with each other based on the estimated predicted route, and
execute driving assistance for the vehicle in accordance with the calculated time to collision.

Although the present invention has been described above using the embodiment, the present invention is not limited to such an embodiment, and various modifications and substitutions can be made without departing from the spirit and scope of the present invention.

What is claimed is:

1. A driving assistance device comprising:
a storage medium storing computer-readable instructions; and
a processor connected to the storage medium, the processor executing the computer-readable instructions to
recognize another vehicle around a vehicle using at least one of a camera and a radar mounted on the vehicle,
calculate a yaw rate of the other vehicle based on a speed vector of the other vehicle and estimate a predicted route of the other vehicle based on the yaw rate to calculate a time to collision until a point where the vehicle and the other vehicle collide with each other based on the estimated predicted route, and
execute driving assistance for the vehicle in accordance with the calculated time to collision.

2. The driving assistance device according to claim 1, wherein the processor calculates the yaw rate of the other vehicle by taking a difference between the latest detection value of the speed vector of the other vehicle and the previous detection value.

3. The driving assistance device according to claim 1, wherein the processor estimates the predicted route of the other vehicle based on an average value of the yaw rates calculated over a predetermined period of time in the past.

4. The driving assistance device according to claim 1, wherein the processor estimates the predicted route of the other vehicle based on the latest value of the yaw rate.

5. The driving assistance device according to claim 1, wherein the processor estimates the predicted route as a stationary circle defined by the yaw rate.

6. The driving assistance device according to claim 1, wherein the processor specifies the point for each of the right and left ends of the vehicle and the other vehicle, and specifies, as a collision point, the point corresponding to the shortest time to collision among the times to collision to the respective points.

7. The driving assistance device according to claim 1, wherein the processor decelerates the vehicle when the time to collision is equal to or less than a threshold value.

8. A driving assistance method comprising:
causing a computer to
recognize another vehicle around a vehicle using at least one of a camera and a radar mounted on the vehicle,
calculate a yaw rate of the other vehicle based on a speed vector of the other vehicle and estimate a predicted route of the other vehicle based on the yaw rate to calculate a time to collision until a point where the vehicle and the other vehicle collide with each other based on the estimated predicted route, and
execute driving assistance for the vehicle in accordance with the calculated time to collision.

9. A computer-readable non-transitory storage medium that stores a program that causes a computer to:
recognize another vehicle around a vehicle using at least one of a camera and a radar mounted on the vehicle,
calculate a yaw rate of the other vehicle based on a speed vector of the other vehicle and estimate a predicted route of the other vehicle based on the yaw rate to calculate a time to collision until a point where the vehicle and the other vehicle collide with each other based on the estimated predicted route, and
execute driving assistance for the vehicle in accordance with the calculated time to collision.
